(19) United States
(12) Patent Application Publication
(10) Pub. No.: US 2012/0116924 A1
(43) Pub. Date: May 10, 2012

(54) ONLINE PRODUCT SELLING METHOD, AND SERVER AND SYSTEM FOR IMPLEMENTING THE SAME

(75) Inventor: Kwangwoon Seo, Seoul (KR)

(73) Assignee: NAMU INTERNET, Seoul (KR)

(21) Appl. No.: 13/291,140

(22) Filed: Nov. 8, 2011

Related U.S. Application Data
(60) Provisional application No. 61/413,413, filed on Nov. 13, 2010.

(30) Foreign Application Priority Data
Nov. 8, 2010 (KR) 10-2010-0110667
Nov. 12, 2010 (KR) 10-2010-0112942

(51) Int. Cl. G06Q 30/06

(52) U.S. Cl. 705/27.1

(57) ABSTRACT

The present invention relates to an online product selling method and a server and system for implementing the method. The online product selling method is performed by an online product selling server. At least one open selling web page in which detailed product information including a name and a provider of each product is displayed is registered. At least one closed selling web page in which riddle data associated with at least one of a name and a provider of each product is displayed and in which detailed product information including the name and the provider of the product is not displayed is registered. A web page transmission request is received from a relevant terminal. Any one of the open selling web page and the closed selling web page is transmitted to the terminal. A payment procedure is performed and then the product is sold.

### CROSS-REFERENCE TO RELATED APPLICATIONS

This application claims the priority benefits of Korean Patent Application No. 10-2010-0110667, filed on Nov. 08, 2010 and No. 10-2010-0112942, filed on Nov. 12, 2010. This application also claims priority benefits of U.S. Provisional Application Ser. No. 63/413,413 filed on Nov. 13, 2010. The entirety of the aforementioned applications are incorporated by reference herein.

### BACKGROUND

I. Field of the Invention

The present invention relates generally to an online product selling method, and a server and system for implementing the online product selling method and, more particularly, to a method, which discloses detailed information about a product to the public in stages and then sells the product online, and to a server and system for implementing the method.

II. Description of the Related Art

Social shopping is a kind of electronic commerce scheme in which each specific item is sold at an exceptionally low price for only one day over the Internet and in which transactions are contracted only when the minimum quantity of the item preset by a website operator is sold. Such social shopping is also called social commerce. Social shopping is characterized in that a purchaser can get a discount and a seller can simultaneously obtain the effects of mass sales and publicity thanks to such social shopping. In this shopping, food service tickets, product coupons, service coupons, etc. which do not require delivery have been mainly sold and purchased.

Recently, as social network services have been popularized, and communication environments such as in mobile communication have changed, more evolved social shopping malls have appeared. If conventional online shopping malls are characterized in that purchasers are mainly invited using online advertising or the like, social shopping is characterized in that users who actively utilize social networks widely publicize a product desired to be purchased and participate in purchasing the product, thus adding to the effect of forming a tipping point.

Such social shopping gets a great positive response from, and the cooperation of, a large number of purchasers for a short period of time because only a single item is sold for a day so as to maximize the effect of a tipping point. However, since a single product or service is typically sold per single day via a social shopping website, the number of pieces of content displayed by the relevant website is not large, so that the time for which users stay on the relevant website is short, and the number of times each user visits the relevant website may also be limited. Accordingly, the interest that users have in social shopping websites is decreased. Further, since information about products or services that will be sold in the future is not displayed in its entirety, there is a disadvantage in that the interest a user has in a relevant social shopping website immediately goes down if the user has no intention to purchase the product currently being sold on the relevant website.

### SUMMARY

The following presents a simplified summary of one or more embodiments in order to provide a basic understanding of such embodiments. This summary is not an extensive overview of all contemplated embodiments.

Accordingly, the present invention has been made keeping in mind the above problems occurring in the prior art, and an object of the present invention is to provide an online product selling method and a server and system for implementing the online product selling method, in which the sales of a plurality of products are simultaneously conducted in an online social shopping website, thus increasing interest on the part of the user.

Another object of the present invention is to provide an online product selling method and a server and system for implementing the online product selling method, in which information about products on sale is minimized, thus arousing the curiosity of users.

In order to accomplish the above objects, the present invention provides online product selling method performed by an online product selling server connected to a plurality of terminals over a network, and configured to provide a product selling website including a selling web page individually assigned to each product to the terminals, including (a) registering at least one open selling web page in which detailed product information including a name and a provider of each product is displayed; (b) registering at least one closed selling web page in which riddle data associated with at least one of a name and a provider of each product is displayed and in which detailed product information including the name and the provider of the product is not displayed; (c) receiving a web page transmission request from a relevant terminal; (d) transmitting any one of the open selling web page and the closed selling web page to the terminal in response to the received web page transmission request; and (e) if the payment request for the product corresponding to the web page transmitted at step (d) is received from the terminal, performing a payment procedure and then selling the product.

Preferably, the open selling web page and the closed selling web page may display a selling price of the product in common.

Preferably, the closed selling web page may include a bulletin board dependent on a product that is on sale on the closed selling web page.

Preferably, the closed selling web page may display information about a time at which the detailed product information including the name and the provider of the product is disclosed.

Preferably, the detailed product information may further include at least one of information about a location of a product provision place, information about a product usage method, and information about a product usage period.

Preferably, (e) may include (e-1) receiving a payment request for a product corresponding to the web page transmitted at (d); (e-2) if a sum of a quantity of the product requested to be paid for and a current quantity of the product that has been sold is greater than a preset total quantity of the product, notifying the terminal that selling the product is impossible; and (e-3) if the sum of a quantity of the product requested to be paid for and the current quantity of the product that has been sold is equal to or less than the preset total quantity of the product, receiving payment information from the terminal and completing selling of the product.

Preferably, fixed Uniform Resource Locators (URLs) may be individually allocated to web pages for respective products displayed on the product selling website.

In addition, the present invention provides an online product selling method performed by an online product selling server connected to a plurality of terminals over a network and configured to provide a product selling website, which includes a selling web page individually allocated to each product and configured to sell a limited quantity of the product, to the terminals, including (A) for an identical product, individually storing an open selling web page in which detailed product information, including a name and a provider of the product, and a selling price of the product are displayed, and a closed selling web page in which the detailed product information, including the name and the provider of the product, is not displayed and in which riddle data, associated with at least one of the name and the provider of the product, and the selling price and a discount rate of the product are displayed; (B) providing the closed selling web page via the product selling website; (C) when a preset disclosure time point is reached, replacing the closed selling web page with the open selling web page and providing the open selling web page; and (D) if a payment request for the product is received from a relevant terminal while (B) and (C) are being performed, performing a payment procedure and then selling the product.

Preferably, the closed selling web page may include a bulletin board dependent on the closed selling web page.

Preferably, an identical Uniform Resource Locator (URL) may be allocated to the closed selling web page and to the open selling web page for the identical product.

Preferably, (D) may include (D-1) when the payment request for the product is received from the terminal while (B) is being performed, if a sum of a quantity of the product requested to be paid for and a current quantity of the product that has been sold is greater than a preset closed selling quantity, notifying the terminal that selling the product is impossible and temporarily stopping selling of the product, whereas if the sum is equal to or less than the preset closed selling quantity, receiving payment information from the terminal and completing selling of the product; and (D-2) when the payment request for the product is received from the terminal while (C) is being performed, if a sum of a quantity of the product requested to be paid for and a current quantity of the product that has been sold is greater than a preset open selling quantity, notifying the terminal that selling the product is impossible and terminating selling of the product, whereas if the sum is equal to or less than the preset open selling quantity, receiving payment information from the terminal and completing selling of the product.

Preferably, the open selling web page and the closed selling web page may include a selling price of the product in common.

Preferably, the detailed product information may further include at least one of information about a location of a product provision place, information about a product usage method, and information about a product usage period.

In addition, the present invention provides an online product selling method performed by an online product selling server connected to a plurality of terminals over a network and configured to provide a product selling website, which includes a selling web page individually allocated to each product and configured to sell a limited quantity of the product, to the terminals, including (I) for a single product, storing detailed product information including a name and a provider of the product, riddle data associated with at least one of the name and the provider of the product, and product-related data including product selling initiation time, product disclosure initiation time, product selling termination time, a price of the product, and total quantity of the product; (II) generating, using the riddle data and the price of the product stored at (I), a closed selling web page in which the detailed product information including the name and the provider of the product is not displayed, and in which the riddle data associated with at least one of the name and the provider of the product and the price of the product are displayed, and then providing the closed selling web page from the product selling initiation time to the product disclosure initiation time; (III) generating, using the detailed product information and the price of the product stored at (I), an open selling web page for the product, and providing the open selling web page from the product disclosure initiation time; and (IV) if a payment request for the product corresponding to the web page is received from a relevant terminal while each of (II) and (III) is being performed, performing a payment procedure and then selling the product.

Preferably, the online product selling method may further include if selling of the total quantity of the product is completed while (II) or (III) is being performed, or if the product selling termination time is reached while (III) is being performed, notifying the terminal that selling the product is impossible, and terminating selling of the product.

Preferably, at (I), a closed selling quantity equal to or less than the total quantity of the product may be stored, and if selling of the product corresponding to the closed selling quantity is completed while (II) is being performed, the terminal may be notified that selling the product is impossible, and the selling of the product may be temporarily stopped until the product disclosure initiation time is reached.

Preferably, the closed selling web page may include a bulletin board dependent on the product that is on sale on the closed selling web page.

Preferably, the open selling web page and the closed selling web page may display a selling price of the product in common.

Preferably, each of the open selling web page and the closed selling web page may display at least one of the product disclosure initiation time, the product selling termination time, and information about a product provision area.

In addition, the present invention provides an online product selling server connected to a plurality of terminals over a network and configured to provide a product selling website, which includes at least one selling web page individually allocated to each product and configured to sell a limited quantity of the product, to the terminals, including a web page provision unit for, for an identical product, storing two web pages classified into an open selling web page in which detailed product information, including a name and a provider of the product, and a selling price of the product are displayed, and a closed selling web page in which the detailed product information including the name and the provider of the product is not displayed and in which riddle data associated with at least one of the name and the provider of the product, and the selling price and a discount rate of the product, are displayed; a web page transmission unit for transmitting the closed selling web page to a relevant terminal before a preset product disclosure initiation time, and transmitting the open selling web page to the terminal after the product disclosure initiation time; a data reception unit for receiving a product selling request via each of the closed selling web page and the open selling web page; and a payment unit for, when the product selling request is received via the data reception unit, performing a payment procedure.

Preferably, the closed selling web page may include a bulletin board dependent only on each closed selling web page, and information about the selling price, a discount rate and selling time of the product.

Preferably, the open selling web page may further include at least one of information about a location of a product provision place, information about a product usage method, and information about a product usage period.

Preferably, the online product selling server may further include a data input unit for receiving data included in the closed selling web page and the open selling web page provided by the web page provision unit.

Preferably, the web page provision unit may be configured such that, depending on a closed selling quantity and a total quantity preset for an identical product, if the closed selling quantity of the product is sold out before the product disclosure initiation time, the web page provision unit displays information indicating temporary stoppage of selling of the product on the closed selling web page, and such that if the total quantity of the product is sold out after the product disclosure initiation time, the web page provision unit displays information indicating termination of selling of the product on the open selling web page.

In addition, the present invention provides an online product selling system including one or more terminals and an online product selling server which are connected to one another over a network, wherein the online product selling server provides an online product selling website to the one or more terminals over the network, and conducts product selling by performing a payment procedure when a product selling request is received from a relevant terminal, and wherein the online product selling website may be configured to include at least one closed selling web page in which detailed product information, including a name and a provider of each product, is not displayed and in which riddle data associated with at least one of the name and the provider of the product is displayed.

Preferably, the online product selling website provided by the online product selling server may be configured to include an open selling web page in which the detailed product information including the name and the provider of each product is displayed.

In this case, the online product selling server may store both the closed selling web page and the open selling web page for an identical product, and may provide the closed selling web page before a preset product disclosure initiation time and may provide the open selling web page after the product disclosure initiation time, to the terminal via an identical single Uniform Resource Locator (URL).

Further, the present invention provides an online product selling system including one or more terminals and an online product selling server which are connected to one another over a network, wherein the online product selling server provides an online product selling website to the one or more terminals over the network, and conducts product selling by performing a payment procedure when a product selling request is received from a relevant terminal, and wherein product-related data which is disclosed on the product selling web page provided to sell the product may gradually increase in stages with passage of time or with an increase in the quantity of the product sold.

Preferably, the online product selling server may primarily disclose riddle data, associated with at least one of the name and the provider of the product, and the product price, and subsequently disclose the name and the provider of the product.

In addition to the exemplary aspects and embodiments described above, other aspects and embodiments will become apparent to those having ordinary skill in the art by reference to the drawings and by study of the following descriptions.

### BRIEF DESCRIPTION OF THE DRAWINGS

FIG. 1 is a diagram showing the schematic construction of an online product selling system according to an embodiment of the present invention;

FIG. 2 is a block diagram showing the schematic construction of an online product selling server according to an embodiment of the present invention;

FIG. 3 is a block diagram showing the schematic construction of an online product purchase terminal according to an embodiment of the present invention;

FIG. 4 is a flowchart showing the steps of an online product selling method according to an embodiment of the present invention;

FIG. 5 is a flowchart showing the steps of an online product selling method according to another embodiment of the present invention;

FIG. 6 is a diagram illustrating a web page for open product selling in the online product selling method according to an embodiment of the present invention; and

FIG. 7 is a diagram illustrating a web page for closed product selling in the online product selling method according to an embodiment of the present invention.

### DETAILED DESCRIPTION

Hereinafter, preferred embodiments of the present invention will be described in detail with reference to the drawings, wherein like reference numerals are used to refer to like elements throughout. In the following description, for purpose of explanation, numerous specific details are set forth in order to provide a thorough understanding of the aspects and features of the present invention and methods for achieving the aspects and features. However, the present invention is not limited to the embodiments disclosed hereinafter. It should be apparent that the teaching herein can be embodied in a wide variety of forms and that any specific matters defined in the description, such as the detailed construction and elements, is merely representative. Based on teachings herein one skilled in the art should appreciate that an aspect disclosed herein can be implemented independently of any other aspects.

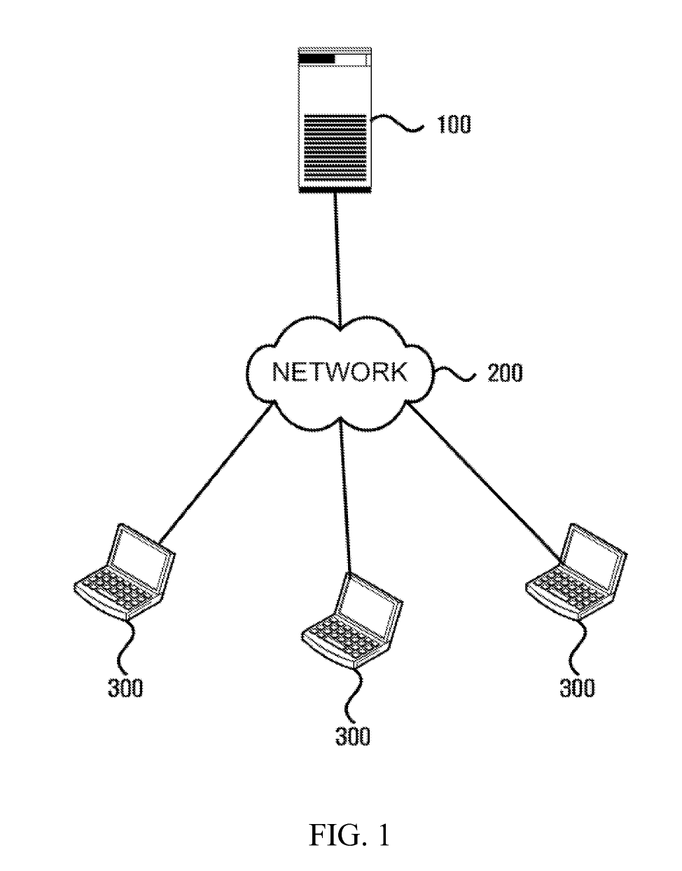

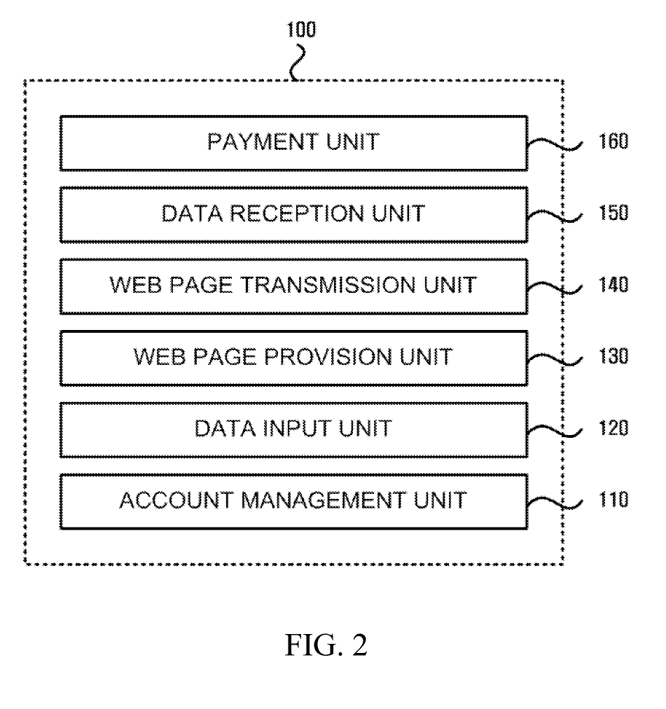

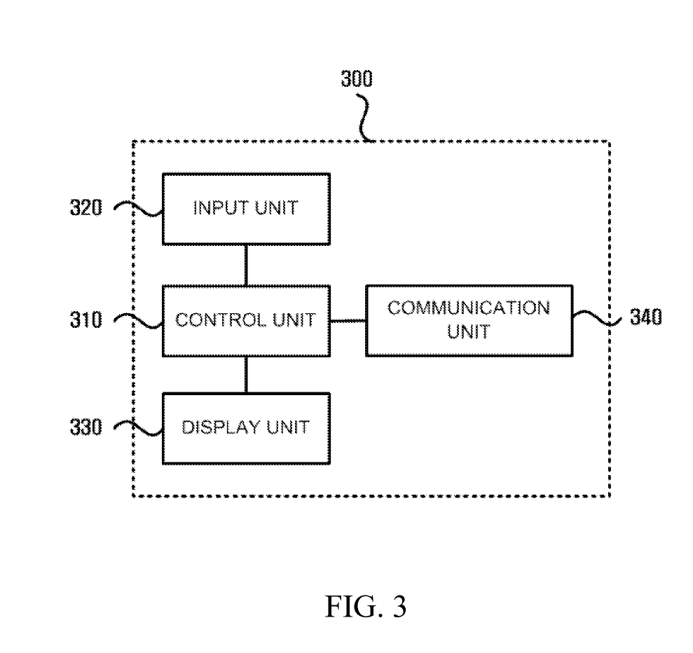

FIG. 1 is a diagram showing the schematic construction of an online product selling system according to an embodiment of the present invention, FIG. 2 is a block diagram showing the schematic construction of an online product selling server according to an embodiment of the present invention, and FIG. 3 is a block diagram showing the schematic construction of an online product purchase terminal according to an embodiment of the present invention.

As shown in FIG. 1, an online product selling system according to an embodiment of the present invention includes an online product selling server 100. The online product selling server 100 functions to provide a service at the request of a plurality of terminals 300 connected thereto via a network 200. In this case, the online product selling server 100 provides a kind of service for selling a specific product or service to the plurality of terminals 300 after receiving payments, at the request of the terminals. In particular, the online product selling server 100 may be a server for providing a social shopping service via a website.

The above-described online product selling server 100 includes an account management unit 110, as shown in FIG. 2. The account management unit 110 functions to manage the accounts of respective users that are allocated to assign the rights to use the service provided via the website provided by the online product selling server 100 to users who have been registered as members of the website. Together with this function, the account management unit 110 may function to store and manage member information, payment details, service usage details, etc. related to the respective users to which user accounts have been allocated.

Further, the online product selling server 100 includes a data input unit 120. The data input unit 120 is used by the manager of the online product selling server 100 to input product-related data such as the contents, prices, product quantity, selling quantity, product selling time, date, etc. of products or services that are sold by the online product selling server 100, and to register data about new products. In particular, the manager may create and input a web page including various types of data related to the products or services on sale using the data input unit 120.

Furthermore, the online product selling server 100 includes a web page provision unit 130. The web page provision unit 130 provides individual web pages constituting the website provided by the online product selling server 100. After storing the web pages created by the data input unit 120, the web page provision unit 130 functions to provide the web pages at the request of a web page transmission unit 140, which will be described later. In particular, the web pages provided by the web page provision unit 130 are programmed to include the product-related data that has been input to the data input unit 120 and the user information or the like that has been stored in the account management unit 110. Further, the web page provision unit 130 stores therein separate web pages required to sell respective products. That is, the web page provision unit 130 stores a single web page for one product. In this case, there are two types of web pages for individual products, which are an open selling web page in which the type and provider of a product or service on sale are specified in detail to allow users to gain accurate information about the product on sale, and a closed selling web page in which the type and provider of a product or service on sale are not definitely specified and only indirect information about the product or service is provided to allow users to merely guess about the product that is on sale. Furthermore, the web page provision unit 130 functions to update the stored web pages, with the lapse of time, or depending on the quantity of each product sold or data input from the product purchase terminal 300. In this regard, the two types of web pages stored in the web page provision unit 130 are stored in such a way that when the manager inputs product-related data via the data input unit 120 and selects one or more of the two types of web pages, the web page provision unit 130 creates web pages on the basis of a preset layout using the input data, so that the created web pages are stored in the web page provision unit 130. Alternatively, it is also possible that the manager can personally configure different types of web pages via the data input unit 120 and store the web pages in the web page provision unit 130, as described above.

The web page provision unit 130 also functions to update the stored web pages depending on variations in the data. For example, as the quantity of a product sold increases, the quantity of the product that is available gradually decreases. Therefore, the quantity of the product sold is monitored and then the available quantity of the product to be displayed on a web page can be updated. Furthermore, when there is data that is displayed differently with the lapse of time, it is determined whether the time has elapsed, and then the display on the web page may be changed.

Further, the online product selling server 100 includes a web page transmission unit 140 for receiving a web page from the web page provision unit 130 at the request of the product purchase terminal 300, and transmitting the web page to the product purchase terminal 300. When a web page transmission request is received from the product purchase terminal 300, the web page transmission unit 140 transmits the web page stored in the web page provision unit 130 to the product purchase terminal 300.

Accordingly, the online product selling server 100 includes a data reception unit 150 for receiving commands or data, entered by a user into the product purchase terminal 300 via the web pages provided to the product purchase terminal 300, after the web pages constituting the website provided by the online product selling server 100 to the product purchase terminal 300 have been provided. The data reception unit 150 not only receives commands such as a web page transmission request, a login request, and a product selling request from the product purchase terminal 300, but also receives data such as text or images posted by the user on a bulletin board or the like. The web page transmission request received by the data reception unit 150 is transferred to the web page transmission unit 140, so that a requested web page can be transmitted to the product purchase terminal 300. The login request is transferred to the account management unit 110, so that an authentication procedure can be walked through. Text data or the like that is to be posted on a bulletin board is transferred to the web page provision unit 130, and is then used to update the web page.

Meanwhile, the online product selling server 100 includes a payment unit 160. The payment unit 160 performs a payment procedure for the amount of money corresponding to the price and quantity of a requested product when a product selling request is received by the data reception unit 150. The payment unit 160 receives payment information from the user and then receives the payment for the sold product using the payment information. Further, the payment unit 160 may perform a procedure for giving a refund for a sold product if the selling of the product is annulled depending on the circumstances.

The online product selling server 100 having the above construction may be configured as a single server or as a server group composed of a plurality of servers. The components of the above-described online product selling server 100 may also be implemented as individual servers that are discriminated from one another.

Meanwhile, the above online product selling server 100 is capable of communicating with the plurality of terminals 300 over the network 200, as described above. Here, each online product purchase terminal 300 is an information processing device such as a typical Personal Computer (PC) or a smart phone, and has the construction shown in FIG. 3.

That is, the product purchase terminal 300 includes a control unit 310. The control unit 310 is a data processing means for performing overall control of the product purchase terminal 300, and performs the analysis of commands, the computation of data, etc.

Further, the product purchase terminal 300 includes an input unit 320 via which a user inputs commands or data. The commands or data input by the input unit 320 is transferred to and processed by the control unit 310.

The product purchase terminal 300 includes a display unit 330. The display unit 330 is an image output means, and functions to display the results of data processing based on the user's command that has been input by the input unit 320, thus allowing the user to view the results of data processing.

The product purchase terminal 300 includes a communication unit 340. The communication unit 340 is a means for allowing the product purchase terminal 300 to communicate with other devices connected to the network 200, and functions to transmit signals that are output from the product purchase terminal 300, and receive signals that are input to the product purchase terminal 300.

Accordingly, when, for example, the user commands the product purchase terminal 300 to be linked to a specific web page via the input unit 320, the control unit 310 receives the command and transmits a web page transmission request to the network 200 via the communication unit 340. Further, when data about the web page desired by the user is received via the communication unit 340 in response to the web page transmission request, the control unit 310 displays a relevant web page on the display unit 330.

According to the above construction, the product purchase terminal 300 is provided with a product selling service via the website provided by the online product selling server 100 while communicating with the online product selling server 100 over the network 200. Hereinafter, a method of selling products in a system in which the online product selling server 100 and the product purchase terminal 300 are connected to each other over the network 200 will be described in detail.

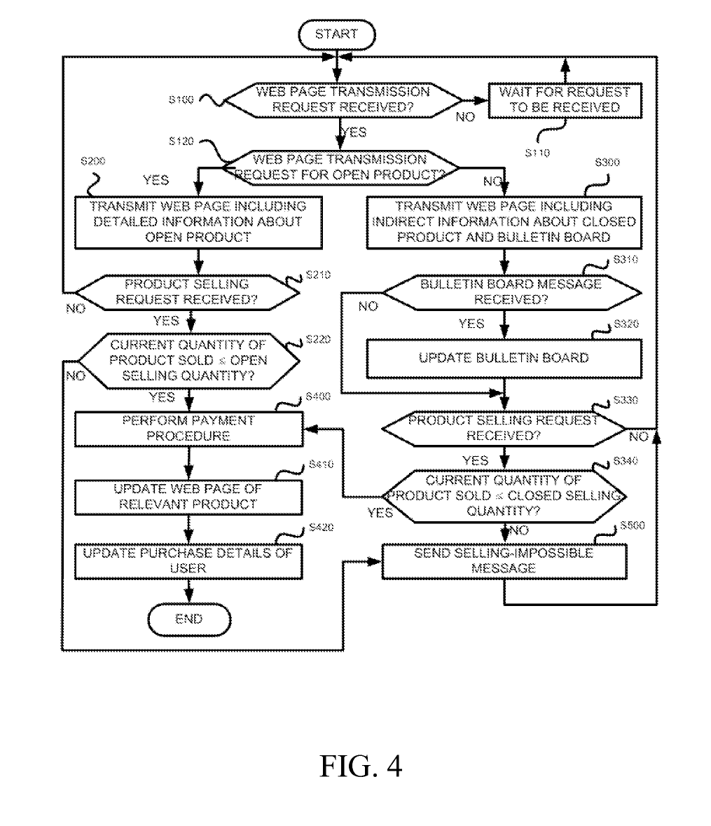

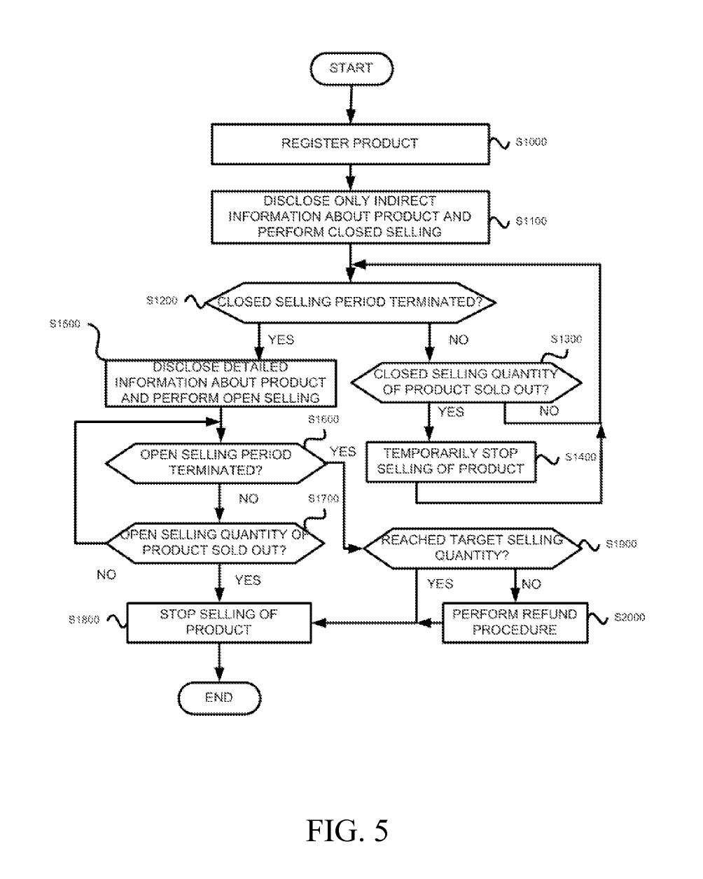

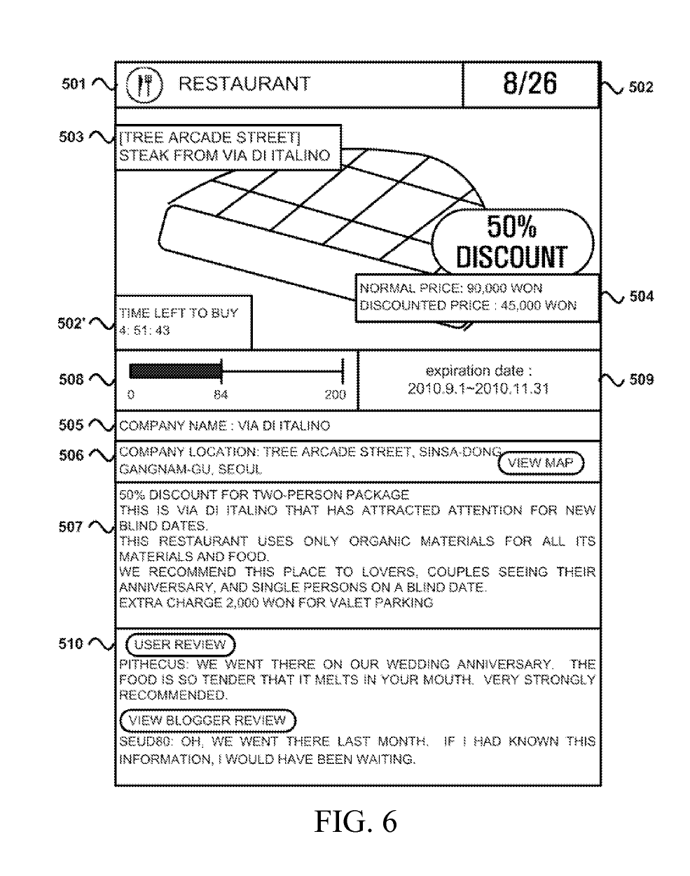

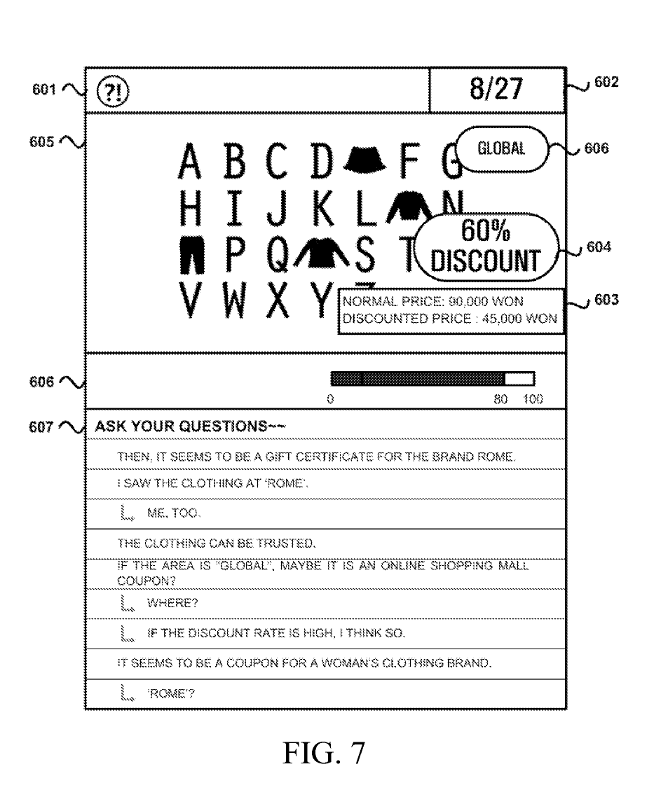

FIG. 4 is a flowchart showing the steps of an online product selling method according to an embodiment of the present invention, FIG. 5 is a flowchart showing the steps of an online product selling method according to another embodiment of the present invention, FIG. 6 is a diagram illustrating a web page for open product selling in the online product selling method according to an embodiment of the present invention, and FIG. 7 is a diagram illustrating a web page for closed product selling in the online product selling method according to an embodiment of the present invention.

In embodiments of the present invention, which will be described later, the term ‘product’ is used as a broad meaning including services as well as substantial goods. The term ‘open selling’ denotes a scheme for selling products while notifying the user of the providers and contents of products on sale via a web page. The term ‘closed selling’ denotes a scheme for selling products while disclosing only indirect information enabling the providers and contents of products to be guessed on a web page without disclosing the providers nor contents of products on sale. Further, the term ‘open product’ denotes a product that is on sale via open selling (on open sale), as described above, and refers to a product that is being sold in the state in which the user can accurately be aware of the product on sale by disclosing detailed information about the provider and contents of the product that were closed to the public. The term ‘closed product’ denotes a product that is on sale via closed selling (on closed sale), and refers to a product that is being sold in the state in which users can merely guess about a product on sale because detailed information about the provider and contents of the product has not been disclosed to the public.

Here, the indirect information disclosed on the web page in relation to a closed product includes images, text, video or audio data including riddles with which the contents, the provider, the name, etc. of a relevant product can be associated. Furthermore, a web page for a closed product may include information about the selling price, the discount rate, and price before discount of a relevant product, an area in which the product is provided, etc.

As shown in FIG. 4, the online product selling method according to an embodiment of the present invention begins at step S100 where a web page transmission request is transferred from the product purchase terminal 300 to the online product selling server 100. Until the web page transmission request is received, the online product selling server 100 waits for a web page transmission request at step S110.

When the web page transmission request is received from the product purchase terminal 300 at step S100, whether the web page transmission request is for an open product or for a closed product is determined at step S120. As described above, the web page provision unit 130 provides two types of web pages: one type is a web page for a closed product in which indirect information about a product is provided so that the product is sold via closed selling, and the other type is a web page for an open product in which detailed and direct information about a product enabling the product to be specified is provided so that the product is sold via open selling.

That is, if it is determined at step S120 that the user's web page transmission request is a web page transmission request for an open product, a web page including the detailed information about the open product is transmitted to the terminal 300 which requested the web page at step S200. In this case, the web page for the open product, which is transmitted to the product purchase terminal 300 at step S200, may include detailed product information enabling the product on sale to be specified, such as the provider of the product, the name or contents of the provided product, the location of a place where the product is provided, a product receipt method (in the case of a service, a service usage method), user reviews, and product-related options. In addition, the web page for the open product may also include an area in which the product is provided, the selling time of the product, the total quantity of the product, the current quantity of the product sold, the selling price of the product, the discount rate of the product, a bulletin board, etc.

For example, when a product sold via open selling is clothing, a clothing brand name enabling the origin of the product to be known, a product name specifying the kind of clothing product, product contents such as the material or size of the clothing, a clothing receipt method, etc. are displayed on the web page transmitted at step S200. Further, when a service sold via open selling is a pass for an amusement park, the title of the service provision company specifying the provider of the service, the kind of available service, the detailed contents of the service, the place where the amusement park is located, etc. may be included in the web page transmitted at step S200.

That is, as shown in FIG. 6, when steak from a specific restaurant, for example, is being sold at a social shopping website, a web page for selling the steak via open selling may display a product category 501, the product selling date and time 502 and 502′, a product title 503 in which pieces of direct information related to the product, such as the product name or type, a product provider, and a product provision location, are integrated and indicated, a product price and discount rate 504, the name of the product provider 505, a place 506 at which the product is provided, product details 507 in which the contents of the product are specified in detail, a field 508 for the total quantity of the product on open sale and the current quantity of the product sold, a product provision period 509, etc. Moreover, the web page may further display user reviews 510 on the product, a bulletin board, etc.

After the above-described web page has been provided to the product purchase terminal 300 at step S200, a selling request for a product on open sale is received from the product purchase terminal 300 at step S210, the online product selling server 100 updates the current quantity of the product sold by adding the quantity of the product requested to be currently sold to the existing quantity of the product sold, with respect to the product on open sale, and then compares the total product quantity with the current quantity of the product sold at step S220. If the current quantity of the product sold is not greater than the total quantity of the product on open sale, the online product selling server 100 receives payment information from the product purchase terminal 300 and processes payment for the sold product using the payment unit 160 on the basis of the price of the product and the quantity of the product purchased at step S400.

Once the payment for the sold product has been completed at step S400, the selling of the product is confirmed, and the web page provision unit 130 updates the web page of the relevant open product at step S410. In particular, at step S410, the web page provision unit 130 updates the field 508 indicating the total quantity of the open product and the current quantity of the product sold in the embodiment as shown in FIG. 6. Further, if the current quantity of the product sold reaches the total product quantity, the web page provision unit 130 displays the fact that the selling of the open product has been completed on the web page in which the product is sold via open selling.

In addition, after the payment procedure has been completed and the selling of the product has been confirmed at step S400, the account management unit 110 updates user information by adding the newly purchased product to the purchase details of the account of the user who purchased the product, and adding the amount of money newly paid to payment details at step S420.

However, if it is determined at step S220 that the current quantity of the product sold is greater than the total product quantity, the online product selling server 100 sends a selling-impossible message to the product purchase terminal 300 at step S500.

Meanwhile, if it is determined at step S120 that the user's web page transmission request is a web page transmission request for a closed product, the online product selling server 100 transmits a web page including the indirect information about the closed product that is being sold via closed selling and a bulletin board to the product purchase terminal 300 at step S300. The web page transmitted at step S300 and required to sell the closed product includes indirect information about the product and the bulletin board. As described above, the indirect information includes riddle data about the product (data including one or more of riddle text, images, video, and audio) with which at least one of the provider, name and contents of the product is associated. Further, the web page for the closed product transmitted at step S300 displays the selling price of a relevant product, the discount rate of the product, the total quantity of the product that can be sold via closed selling, and the current quantity of the product sold, and may additionally display information about an area where the relevant product is provided, together with the above information.

For example, as shown in FIG. 7, on the web page provided at step S300 and required to sell a closed product, a product category is not displayed in a product category field 601, but date information 602 about a date on which selling switches from closed selling to open selling, price information 603, and discount rate information 604 are displayed. Further, riddle data 605, with which at least one of the name, the provider and the contents of the product on closed sale is associated, is provided in the form of an image or text. Further, the field 606 indicating total quantity of the product on closed sale (that can be sold via closed selling) and the current quantity of the product sold is displayed. Furthermore, in the web page, the bulletin board 607 on which users' opinions are exchanged is provided to allow the users to easily infer the product currently being sold via closed selling from the riddle data 605. Here, it is appropriate to provide the bulletin board 607 as bulletin boards dependent on the respective closed products that are being sold via closed selling so that users can individually exchange their opinions with one another about individual closed products.

That is, for each product that is being sold via closed selling, since the provider or the detailed contents of the product are not disclosed to the public, the product on sale is not specified. Accordingly, users become curious to know which the relevant product is and which company, brand or store corresponds to the provider. In order to satisfy such curiosity, it is possible to solve riddles corresponding to the riddle data in such a way that a user posts a question on a bulletin board dependent on the product or answers a relevant question. That is, the bulletin board is provided such that users share their own information, experiences or the like on the bulletin board and guess about a product that is being sold via closed selling, by which it is possible to specify a closed product.

Further, if a bulletin board message is received from the product purchase terminal 300 at step S310 after the web page for the closed product has been transmitted to the product purchase terminal 300 at step S300, the web page provision unit 130 updates the received bulletin board message on the bulletin board included in the web page of the closed product at step S320.

Thereafter, when a product selling request from the product purchase terminal 300 is received by the online product selling server 100 at step S330, it is determined whether the current quantity of the closed product sold is greater than the total quantity of the closed product at step S340. Further, if it is determined at step S340 that the current quantity of the closed product sold is equal to or less than the total quantity of the closed product, a payment procedure is performed at step S400, the quantity of the closed product sold is updated on the web page at step S410, and then the purchase details of each user who purchased the closed product are updated at step S420.

In contrast, if it is determined at step S340 that the value obtained by adding the current quantity of the product sold to the existing quantity of the product sold is greater than the total quantity of the closed product, a selling-impossible message is sent to the product purchase terminal 300 so that the selling-impossible message is displayed on the web page of the closed product at step S500.

By means of the above-described series of procedures, the detailed description of a product is disclosed on the web page of an open product to allow the user to specify the product on sale. Direct information about a product enabling the product to be specified is not disclosed on the web page for selling a closed product, so that the curiosity about the closed product is aroused, and the contents of the product may be guessed about even when the product is in a closed state, thus allowing the user to purchase the product.

Meanwhile, separate Uniform Resource Locators (URLs) are allocated to web pages for the open product and the closed product provided at steps S200 and S300, and then the users can immediately go to the web pages for selling the respective products over a social network. In this case, since fixed URLs are allocated to the respective web pages, products corresponding to web pages may not be changed even if hypertext links that link to the web pages selling the relevant products are displayed on other social networks.

Here, the open product and the closed product may be separate products, or, alternatively, a product that was sold as a closed product may be changed to an open product at a specific time point and may be sold as an open product. For example, when it is desired to sell 1000 pieces of product A, 300 pieces may be sold via closed selling, and after a specific time point, the remaining 700 pieces may be sold with the detailed information about the product disclosed to the public. In this case, when the same product is sold via open selling after closed selling, better benefit may be provided to a purchaser, who purchased the relevant product in a closed state, than that provided to a purchaser who purchased the product in an open state. Further, the time point at which a closed product is switched to an open product can be adjusted depending on the quantity of the product sold.

This operation will be described in detail with reference to the attached drawings. As shown in FIG. 5, a new product is registered in the online product selling server 100 by a manager at step S1000. Here, step S1000 may be performed such that an open selling web page and a closed selling web page for a single new product are individually registered in the web page provision unit 130, or such that after detailed product information required to sell the new product via open selling and indirect information required to sell the new product via closed selling have been stored together, the web page provision unit 130 automatically creates an open selling web page and a closed selling web page using the stored information. Further, at step S1000, the initiation time point of the closed selling of the product, the initiation time point of the open selling of the product, the termination time point of selling, the quantity of the product, the target selling quantity of the product, etc. are also stored together.

Here, the stored product quantity may include only the total quantity of a newly registered product, or may include the preset quantity of the product to be sold via closed selling (closed selling quantity) and the preset quantity of the product to be sold via open selling (open selling quantity) in the total product quantity. Storing only the total product quantity may denote the case where the closed selling quantity and the open selling quantity are not separately designated, and the total product quantity can be designated to be sold via closed selling. Further, the target selling quantity is a quantity corresponding to the tipping point of social shopping, and refers to a product quantity defined such that if the final quantity of the product sold does not reach the target selling quantity, the selling of the product is annulled and previous payment is refunded.

Here, the open selling web page denotes a web page that is transmitted at step S200 and that includes detailed product information enabling a relevant product to be specified in the embodiment of the present invention which has been described with reference to FIG. 4. The closed selling web page denotes a web page that is transmitted at step S300 of FIG. 4 and that includes indirect information about the product and a bulletin board.

At step S1000, when a closed selling time point previously set for the new product is reached after the registration of the new product has been completed as described above, the web page transmission unit 140 discloses the closed selling web page for the relevant product to the public at step S1100.

Further, after the closed selling web page for the product has been disclosed to the public at step S1100, the web page transmission unit 140 monitors whether the open selling initiation time point, preset at step S1000, has been reached and then closed selling has been terminated at step S1200.

Subsequently, at step S1300, it is determined whether the available quantity of the product remains in such a way that if the closed selling quantity of the product is separately stored at step S1000, it is determined whether the closed selling quantity of the product has been sold out, whereas if the closed selling quantity is not separately stored, it is determined whether the total quantity of the product has been sold out. If it is determined at step S1300 that the available quantity of the product does not remain, the selling of the product is temporarily stopped at step S1400. Then, after the closed selling period has been terminated, the selling of the product may resume.

In contrast, if it is determined at step S1300 that an available quantity of the product remains, the process returns to the step S1200 of monitoring whether the termination time point of closed selling, that is, the initiation time point of open selling, has been reached.

If it is determined at step S1200 that the open selling initiation time point has been reached, the web page transmission unit 140 displays an open selling web page including the detailed information about the product, and then starts open selling at step S1500.

When the open selling of the product starts at step S1500, it is monitored whether the selling termination time point preset at step S1000 has been reached at step S1600.

If it is determined at step S1600 that the open selling period has not yet been terminated, it is determined whether the current quantity of the product sold has reached the preset open selling quantity or the total selling quantity and then there is no available quantity of the product at step S1700.

If it is determined at step S1700 that there is no available quantity of the product, the selling of the product is stopped at step S1800.

Meanwhile, if it is determined at step S1600 that the open selling period has been terminated, it is determined whether the final quantity of the product sold has reached the target selling quantity, preset at step S1000, at step S1900. If it is determined at step S1900 that the final quantity of the product sold has reached the target selling quantity, the selling of the product is stopped at step S1800. In contrast, if it is determined at step S1900 that the final quantity of the product sold does not reach the target selling quantity, a procedure for giving a refund on all quantity of the product sold is performed at step S2000, and thereafter the selling of the product may be stopped.

As shown in FIG. 5, when, for the same product, the closed selling web page is provided and is then switched to the open selling web page at the preset open selling initiation time point, and the open selling web page is displayed since then, the closed selling web page may be provided to the product purchase terminal 300 via the website when the closed selling period is terminated, that is, from the date which is a predetermined period before the disclosure time point of the detailed information about the product. For example, a closed selling web page, designated to be switched to an open selling web page on November 1, may be provided from the date which is three days, corresponding to the predetermined period, before November 1, that is, at October 29. According to this method, if one product is on sale for a day as an open product, three closed products are simultaneously sold together with the open product. That is, on the basis of October 29, one open product is sold on October 29 via open selling, and it may be simultaneously sold with three closed products, which will be respectively sold on October 30 and 31 and November 1 via open selling. The predetermined period may be lengthened or shortened as necessary. If the predetermined period is set to be short, the number of products that are simultaneously sold may decrease, whereas if the predetermined period is set to be long, the number of products that are simultaneously sold may increase.

However, the above method is not necessarily used to conduct closed selling and open selling, and it is also possible to provide web pages using a method of simultaneously registering closed selling web pages for a plurality of products, which will be sold via open selling in a predetermined period, on the website, providing the registered web pages to the product purchase terminal 300, and registering no more web pages for other products until the predetermined period has elapsed.

In the above-described embodiments, although the separate selling of one identical product has been described as taking place in two steps, that is, a closed selling step and an open selling step, there is no need to necessarily divide the disclosure level of the information about the product into two steps, and it is also possible to implement an embodiment in which the information disclosure level is subdivided into three or more steps and then the disclosure level of information about a product is gradually raised.

Those skilled in the art will appreciate that the present invention may be implemented in other detailed forms without changing the technical spirit or essential features of the present invention. Therefore, it should be understood that the above-described embodiments are merely exemplary and are not limited in all aspects. The scope of the present invention is defined by the accompanying claims rather than the detailed description, and all changes or modifications derived from the meanings and scope of the accompanying claims and the equivalents thereof should be interpreted as being included in the scope of the present invention. For example, the term ‘product’ in the claims is described as a concept including ‘service’, and the term ‘product’ should be interpreted as including ‘service’ at the time of interpreting the meanings and scope of the claims.

As described above, the online product selling method and the server and system for implementing the method according to the present invention have the following advantages.

In detail, there is an advantage in that sales for a plurality of products are simultaneously conducted, so that user interest in online social shopping websites is increased, and a larger number of users are induced to frequently visit the online social shopping websites, thus increasing the number of fixed customers.

Further, the online product selling method and the server and system for implementing the method according to the present invention are advantageous in that information about products is minimized to arouse users' curiosity, so that the time that each user stays on an online social shopping website is lengthened, and the number of times each user accesses the website increases, thus increasing the rate of sales of products and enhancing advertising effects.

Furthermore, the online product selling method and the server and system for implementing the method according to the present invention are advantageous in that information about products is disclosed to the public in stages, so that the user interest in a relevant website is stimulated to induce a user to repeatedly access the website, thus additionally attracting interest in products other than the one user was primarily interested in.

What is claimed is:

1. An online product selling method performed by an online product selling server connected to a plurality of terminals over a network, and configured to provide a product selling website including a selling web page individually assigned to each product to the terminals, comprising:
(a) registering at least one open selling web page in which detailed product information including a name and a provider of each product is displayed;
(b) registering at least one closed selling web page in which riddle data associated with at least one of a name and a provider of each product is displayed and in which detailed product information including the name and the provider of the product is not displayed;
(c) receiving a web page transmission request from a relevant terminal;
(d) transmitting any one of the open selling web page and the closed selling web page to the terminal in response to the received web page transmission request;
(e-1) receiving a payment request for a product corresponding to the web page transmitted at (d);
(e-2) if a sum of a quantity of the product requested to be paid for and a current quantity of the product that has been sold is greater than a preset total quantity of the product, notifying the terminal that selling the product is impossible; and
(e-3) if the sum of a quantity of the product requested to be paid for and the current quantity of the product that has been sold is equal to or less than the preset total quantity of the product, receiving payment information from the terminal and completing selling of the product.

2. The online product selling method according to claim 1, wherein the open selling web page and the closed selling web page display a selling price of the product in common.

3. The online product selling method according to claim 1, wherein the closed selling web page includes a bulletin board dependent on a product that is on sale on the closed selling web page.

4. The online product selling method according to claim 1, wherein the closed selling web page displays information about a time at which the detailed product information including the name and the provider of the product is disclosed.

5. The online product selling method according to claim 1, wherein the detailed product information further includes at least one of information about a location of a product provision place, information about a product usage method, and information about a product usage period.

6. The online product selling method according to claim 3, wherein the detailed product information further includes at least one of information about a location of a product provision place, information about a product usage method, and information about a product usage period.

7. The online product selling method according to claim 1, wherein fixed Uniform Resource Locators (URLs) are individually allocated to web pages for respective products displayed on the product selling website.

8. An online product selling method performed by an online product selling server connected to a plurality of terminals over a network and configured to provide a product selling website, which includes a selling web page individually allocated to each product and configured to sell a limited quantity of the product, to the terminals, comprising:
(A) for an identical product, individually storing an open selling web page in which detailed product information, including a name and a provider of the product, and a selling price of the product are displayed, and a closed selling web page in which the detailed product information, including the name and the provider of the product, is not displayed and in which riddle data, associated with at least one of the name and the provider of the product, and the selling price and a discount rate of the product are displayed;
(B) providing the closed selling web page via the product selling website;
(C) when a preset disclosure time point is reached, replacing the closed selling web page with the open selling web page and providing the open selling web page; and
(D) if a payment request for the product is received from a relevant terminal while (B) and (C) are being performed, performing a payment procedure and then selling the product,
wherein the closed selling web page includes a bulletin board dependent on the closed selling web page.

9. The online product selling method according to claim 8, wherein an identical Uniform Resource Locator (URL) is allocated to the closed selling web page and to the open selling web page for the identical product.

10. The online product selling method according to claim 8, wherein (D) comprises:
(D-1) when the payment request for the product is received from the terminal while (B) is being performed, if a sum of a quantity of the product requested to be paid for and a current quantity of the product that has been sold is greater than a preset closed selling quantity, notifying the terminal that selling the product is impossible and temporarily stopping selling of the product, whereas if the sum is equal to or less than the preset closed selling quantity, receiving payment information from the terminal and completing selling of the product; and
(D-2) when the payment request for the product is received from the terminal while (C) is being performed, if a sum of a quantity of the product requested to be paid for and a current quantity of the product that has been sold is greater than a preset open selling quantity, notifying the terminal that selling the product is impossible and terminating selling of the product, whereas if the sum is equal to or less than the preset open selling quantity, receiving payment information from the terminal and completing selling of the product.

11. The online product selling method according to claim 8, wherein the detailed product information further includes at least one of information about a location of a product provision place, information about a product usage method, and information about a product usage period.

12. An online product selling method performed by an online product selling server connected to a plurality of terminals over a network and configured to provide a product selling website, which includes a selling web page individually allocated to each product and configured to sell a limited quantity of the product, to the terminals, comprising:
(I) for a single product, storing detailed product information including a name and a provider of the product, riddle data associated with at least one of the name and the provider of the product, and product-related data including product selling initiation time, product disclosure initiation time, product selling termination time, a price of the product, and total quantity of the product;
(II) generating, using the riddle data and the price of the product stored at (I), a closed selling web page in which the detailed product information including the name and the provider of the product is not displayed, and in which the riddle data associated with at least one of the name and the provider of the product and the price of the product are displayed, and then providing the closed selling web page from the product selling initiation time to the product disclosure initiation time;
(III) generating, using the detailed product information and the price of the product stored at (I), an open selling web page for the product, and providing the open selling web page from the product disclosure initiation time; and
(IV) if a payment request for the product corresponding to the web page is received from a relevant terminal while each of (II) and (III) is being performed, performing a payment procedure and then selling the product,
wherein the closed selling web page includes a bulletin board dependent on the product that is on sale on the closed selling web page.

13. The online product selling method according to claim 12, further comprising:
if selling of the total quantity of the product is completed while (II) or (III) is being performed, or if the product selling termination time is reached while (III) is being performed, notifying the terminal that selling the product is impossible, and terminating selling of the product.

14. The online product selling method according to claim 12, wherein at (I),
a closed selling quantity equal to or less than the total quantity of the product is stored, and
if selling of the product corresponding to the closed selling quantity is completed while (II) is being performed, the terminal is notified that selling the product is impossible, and the selling of the product is temporarily stopped until the product disclosure initiation time is reached.

15. The online product selling method according to claim 12, wherein each of the open selling web page and the closed selling web page displays at least one of the product disclosure initiation time, the product selling termination time, and information about a product provision area.

16. An online product selling server connected to a plurality of terminals over a network and configured to provide a product selling website, which includes at least one selling web page individually allocated to each product and configured to sell a limited quantity of the product, to the terminals, comprising:
a web page provision unit for, for an identical product, storing two web pages classified into an open selling web page in which detailed product information, including a name and a provider of the product, and a selling price of the product are displayed, and a closed selling web page in which the detailed product information including the name and the provider of the product is not displayed and in which riddle data associated with at least one of the name and the provider of the product, and the selling price and a discount rate of the product, are displayed;
a web page transmission unit for transmitting the closed selling web page to a relevant terminal before a preset product disclosure initiation time, and transmitting the open selling web page to the terminal after the product disclosure initiation time;
a data reception unit for receiving a product selling request via each of the closed selling web page and the open selling web page; and
a payment unit for, when the product selling request is received via the data reception unit, performing a payment procedure,
wherein the closed selling web page includes a bulletin board dependent on the closed selling web page.

17. The online product selling server according to claim 16, wherein the open selling web page further includes at least one of information about a location of a product provision place, information about a product usage method, and information about a product usage period.

18. The online product selling server according to claim 16, wherein the web page provision unit is configured such that, depending on a closed selling quantity and a total quantity preset for an identical product, if the closed selling quantity of the product is sold out before the product disclosure initiation time, the web page provision unit displays information indicating temporary stoppage of selling of the product on the closed selling web page, and such that if the total quantity of the product is sold out after the product disclosure initiation time, the web page provision unit displays information indicating termination of selling of the product on the open selling web page.
